(19) United States
(12) Patent Application Publication
(10) Pub. No.: US 2014/0336941 A1
(43) Pub. Date: Nov. 13, 2014

(54) SYSTEM AND METHOD FOR ALIGNING GENOME SEQUENCE IN CONSIDERATION OF READ QUALITY

(71) Applicant: SAMSUNG SDS CO., LTD., Seoul (KR)

(72) Inventor: Minseo PARK, Seoul (KR)

(73) Assignee: SAMSUNG SDS CO., LTD., Seoul (KR)

(21) Appl. No.: 14/057,054

(22) Filed: Oct. 18, 2013

(30) Foreign Application Priority Data
May 9, 2013 (KR) 10-2013-0052682

(51) Int. Cl. G06F 19/22

(52) U.S. Cl. CPC G06F 19/22
USPC 702/19

(57) ABSTRACT

Provided are a system and/or apparatus, and a method, for aligning a genome sequence. The system and/or apparatus includes a corrector configured to correct quality of input reads, a seed generator configured to generate one or more seeds from the corrected reads, and an aligner configured to perform a global alignment operation of the corrected reads in a reference sequence using the generated seeds.

### CROSS-REFERENCE TO RELATED APPLICATION

This application claims priority to and the benefit of Republic of Korea Patent Application No. 10-2013-0052682, filed on May 9, 2013, the disclosure of which is incorporated herein by reference in its entirety.

### BACKGROUND

1. Field

Embodiments of the present disclosure relate to technologies for analyzing a genome sequence, and more particularly, to a system and/or apparatus and method for aligning a genome sequence in consideration of read quality.

2. Discussion of Related Art

Due to low cost and rapid data generation, next generation sequencing (NGS) that generates a massive amount of short sequences is quickly replacing conventional Sanger sequencing. Also, various NGS sequence reassembly programs have been developed with a focus on accuracy.

With the development of NGS technology, the length of a read calculated by a sequencer is increasing more and more. While an initial sequencer calculates a read having a length of about 75 base pairs (bp), a recent sequencer calculates a read having a length of 100 bp or more, and the length of a read is expected to increase up to about 500 bp in the future. Due to such an increase in the length of a calculated read, the quality of a calculated read also becomes important more and more. This is because it is impossible to ensure accuracy in genome sequence analysis when a read of low quality is used. Consequently, there is a need for a technology for improving accuracy and speed in genome sequence analysis in consideration of the quality of a calculated read.

### SUMMARY

Embodiments of the present disclosure are directed to providing a means for aligning a genome sequence capable of improving accuracy and speed in genome sequence analysis by correcting the quality of a read input from a sequencer.

According to an aspect of the present disclosure, there is provided a system for aligning a genome sequence including: a corrector configured to correct quality of input reads; a seed generator configured to generate one or more seeds from the corrected reads; and an aligner configured to perform a global alignment operation of the corrected reads in a reference sequence using the generated seeds.

The corrector may correct the quality of the reads by removing partial sections of the reads.

The corrector may remove the partial sections of the reads in consideration of quality scores of the reads.

The corrector may remove the sections including bases having quality scores less than a predetermined value from the reads.

When the sections including the bases having the quality scores less than the predetermined value in the reads exceed a predetermined length, the corrector may remove the sections.

The corrector may remove sections including unclear bases from the reads.

When at least one of the sums, averages, medians, and maximums of quality scores of specific sections of the reads are less than a predetermined value, the corrector may remove the specific sections.

The corrector may remove sections from bases at which mismatches occur upon exact matching between the reads and the reference sequence to last bases of the reads.

When lengths of the reads from which the partial sections have been removed are less than a predetermined value, the corrector may discard the reads.

When at least one of the sums, averages, medians, and maximums of quality scores of the reads from which the partial sections have been removed are less than a predetermined value, the corrector may discard the reads.

The seed generator may determine one or more of the lengths, numbers, and overlap lengths of the seeds to be generated from the reads according to lengths of the respective corrected reads.

When the reads are split into two or more segments through the correction, the seed generator may determine the lengths, the numbers, or the overlap lengths of the seeds according to the respective split segments.

The aligner may replace removed sections of the corrected reads with one or more dummy bases before performing the global alignment operation.

According to another aspect of the present disclosure, there is provided a method of aligning a genome sequence including: correcting, at a corrector, quality of input reads; generating, at a seed generator, one or more seeds from the corrected reads; and performing, at an aligner, a global alignment operation of the corrected reads in a reference sequence using the generated seeds.

The correcting of the quality of the input reads may include correcting the quality of the reads by removing partial sections of the reads.

The correcting of the quality of the input reads may include removing the partial sections of the reads in consideration of quality scores of the reads.

The correcting of the quality of the input reads may include removing the sections including bases having quality scores less than a predetermined value from the reads.

The correcting of the quality of the input reads may include removing the sections when the sections including the bases having the quality scores less than the predetermined value in the reads exceed a predetermined length.

The correcting of the quality of the input reads may include removing sections including unclear bases from the reads.

The correcting of the quality of the input reads may include, when at least one of the sums, averages, medians, and maximums of quality scores of specific sections of the reads are less than a predetermined value, removing the specific sections.

The correcting of the quality of the input reads may include removing sections from bases at which mismatches occur upon exact matching between the reads and the reference sequence to last bases of the reads.

The correcting of the quality of the input reads may further include discarding the reads when lengths of the reads from which the partial sections have been removed are less than a predetermined value.

The correcting of the quality of the input reads may further include discarding the reads when at least one of the sums, averages, medians, and maximums of quality scores of the reads from which the partial sections have been removed are less than a predetermined value.

The generating of the seeds may include determining one or more of lengths, the numbers, and overlap lengths of the seeds to be generated from the reads according to lengths of the respective corrected reads.

The generating of the seeds may include, when the reads are split into two or more segments through the correction, determining the lengths, the numbers, or the overlap lengths of the seeds according to the respective split segments.

The performing of the global alignment operation may further include replacing removed sections of the corrected reads with one or more dummy bases.

### BRIEF DESCRIPTION OF THE DRAWINGS

The above and other objects, features, and advantages of the present disclosure will become more apparent to those of ordinary skill in the art by describing in detail exemplary embodiments thereof with reference to the accompanying drawings, in which:

FIG. 1 is a block diagram of a system and/or apparatus for aligning a genome sequence according to an exemplary embodiment of the present disclosure;

FIG. 2 is a diagram illustrating an overlap between seeds according to an exemplary embodiment of the present disclosure;

FIG. 3 and FIG. 4 are diagrams comparatively illustrating effects according to an overlap length between seeds in an exemplary embodiment of the present disclosure;

FIG. 5 and FIG. 6 are diagrams illustrating a seed generating method according to the position of a removed section in a read in an exemplary embodiment of the present disclosure; and

FIG. 7 is a flowchart illustrating a method of aligning a genome sequence according to an exemplary embodiment of the present disclosure.

### DETAILED DESCRIPTION OF EXEMPLARY EMBODIMENTS

Hereinafter, detailed embodiments of the present disclosure will be described with reference to the accompanying drawings. However, the embodiments are merely examples and are not to be construed as limiting the present disclosure.

When it is determined that the detailed description of known art related to the present disclosure may obscure the gist of the present disclosure, the detailed description thereof will be omitted. Terminology described below is defined considering functions in the present disclosure and may vary according to a user's or operator's intention or usual practice. Thus, the meanings of the terminology should be interpreted based on the overall context of the present specification.

The spirit of the present disclosure is determined by the claims, and the following exemplary embodiments are provided only to efficiently describe the spirit of the present disclosure to those of ordinary skill in the art.

Prior to detailed description of exemplary embodiments of the present disclosure, terminology used in the present disclosure will be described first.

First, a “read” is genome sequence data of short length output from a genome sequencer. In general, reads have diverse lengths of about 35 to 500 base pairs (bp) according to types of sequencers, and deoxyribonucleic acid (DNA) bases are expressed with letters of A, C, G, and T.

A “reference sequence” is a genome sequence that is referred to so as to generate a whole genome sequence from reads. In genome sequence analysis, a large amount of reads output from a genome sequencer is mapped with reference to a reference sequence, and thereby a whole genome sequence is completed. In the present disclosure, a reference sequence may be a sequence that has been set in advance of genome sequence analysis (e.g., the whole genome sequence of a human), or a genome sequence made by a genome sequencer may be used as a reference sequence.

A “base” is the minimum unit constituting a reference sequence and a read. As mentioned above, DNA bases may be constituted by four letters of A, C, G, and T, each of which is expressed as a base. In other words, DNA bases are expressed with four bases, as are reads. However, in case of a reference sequence, it may be unclear with which base among A, C, G, and T a base at a specific position should be expressed due to various reasons (a sequencing error, an error of a sample, etc.), and such an unclear base is indicated by an additional letter such as N.

A “seed” is a sequence that is a unit for comparison between a read and a reference sequence for mapping of the read. In theory, to map a read to a reference sequence, a mapping position of the read should be calculated by sequentially comparing the whole read with the beginning of the reference sequence. However, such a method requires too much time and computing power to map one read. Thus, in practice, a candidate mapping position of the whole read is found by mapping a seed that is a segment of the read to the reference sequence first, and the whole read is mapped to the candidate position (global alignment).

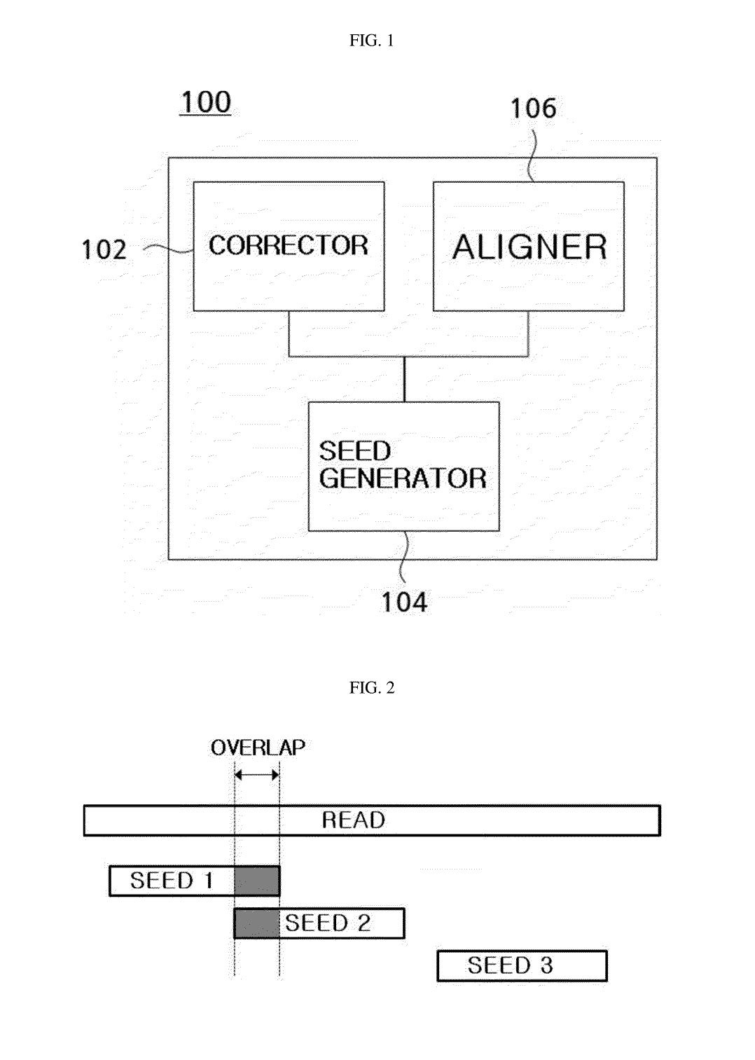

FIG. 1 is a block diagram of a system and/or apparatus for aligning a genome sequence according to an exemplary embodiment of the present disclosure. In an exemplary embodiment of the present disclosure, a system and/or apparatus 100 for aligning a genome sequence is a system and/or apparatus for determining a mapping (or alignment) position of a read output from a genome sequencer in a reference sequence by comparing the read with the reference sequence. As shown in the drawing, the system and/or apparatus 100 for aligning a genome sequence according to an exemplary embodiment of the present disclosure includes a corrector 102, a seed generator 104, and an aligner 106.

The corrector 102 corrects the quality of reads input from the genome sequencer. Specifically, the corrector 102 may correct the quality of the input reads by removing partial sections of the reads. For example, the corrector 102 may be configured to increase overall quality scores of the input reads by removing partial sections of low quality scores in consideration of quality scores of the reads.

In an exemplary embodiment of the present disclosure, the quality score of a read is a score value converted from error probabilities of respective bases constituting the read output from the genome sequencer. There are several methods of calculating the quality score of a read, and for example, a Phred quality score, etc., may be used. However, the present disclosure is not limited to a specific quality score calculating method. Details related to the quality score have been well known to those of ordinary skill in the art, and detailed description thereof will be omitted herein.

Exemplary embodiments for the corrector 102 to correct the quality score of a read will be described below. However, the following exemplary embodiments are merely examples, and the present disclosure is not limited to a specific quality score correcting method.

In an exemplary embodiment, the corrector 102 may be configured to remove a predetermined specific section from a calculated read. In general, rear part of the read has lower quality scores compared with the front part of the read. Thus, the corrector 102 may increase an overall quality score by leaving the front part of the read and cutting off a certain section of the rear part. For example, the corrector may be configured to remove a certain section of 3′ read corresponding to the rear part of the calculated read.

In another exemplary embodiment, the corrector 102 may be configured to remove a section including a base whose quality score is less than a predetermined reference value from a read in consideration of a quality score of the read. Specifically, when the section including the base whose quality score is less than the reference value in the read exceeds a set length, the corrector 102 may remove the section. For example, the corrector 102 may be configured to remove the corresponding section when five or more bases whose quality scores are expressed as #(ASCII code value 23(hexadecimal number)) are repeatedly shown. This will be described below with an example.

First, it is assumed that there is a sample read given below, and the quality score of the read is as follows.

Sample Read:

CTCAAGTAGCTGGCATTACAGGTGCTTGCCAAGACGCGTGTCCAACTTAG

Quality Score:

@ @CFFFFFHDHHDIIGJJJGGIGIIJJJJJJJHIJJJ#############

In the above example, it is possible to know that a base having a quality score of # is repeated 13 times at the end of the sample read. In this case, by removing the last 13 digits from the sample read, the overall quality score of the read can be increased.

Corrected Sample Read:

CTCAAGTAGCTGGCATTACAGGTGCTTGCCAAGACGC

In still another exemplary embodiment, the corrector 102 may be configured to remove a section including an unclear base from a read. For example, the corrector may remove a section indicated by “N.” Like in the preceding exemplary embodiment, the removed section may be replaced with a dummy base.

In still another exemplary embodiment, the corrector 102 may be configured to remove a specific section of a read when at least one of the sum, average, median, and maximum of quality scores of the specific section of the read is less than a predetermined value. For example, the corrector 102 may be configured to remove a rear part of a read that is 50% of the read when the sum of quality scores of the rear part is less than a predetermined value (e.g., 20). Like in the preceding exemplary embodiments, the removed section may be replaced with dummy bases.

In still another exemplary embodiment, the corrector 102 may be configured to remove a section from a base at which a mismatch occur upon exact matching between a read and a reference sequence to the last base of the read. For example, assuming that a mismatch occurs at a 47^{th} base upon exact matching between a read having a length of 100 and a reference sequence, the corrector 102 may cut off a section from the 47^{th} base of the read to the end of the read. Like in the preceding exemplary embodiments, the removed section may be replaced with dummy bases.

Meanwhile, after removing partial sections of reads as described above, the corrector 102 may discard reads that are determined inappropriate to be used in the subsequent genome sequence reassembly process among the corrected reads.

In an exemplary embodiment, the corrector 102 may be configured to discard a read when the length of the read from which a partial section has been removed is less than a predetermined value. For example, when the length of a corrected read is less than half the original length, the corrector 102 may discard the read.

In another exemplary embodiment, when at least one of the sum, average, median, and maximum of quality scores of a corrected read is less than a predetermined value, the corrector 102 may discard the read.

Besides such reads, the corrector 102 may discard reads that are determined inappropriate to be used in the subsequent genome sequence reassembly process among reads corrected according to various criteria, and it should be noted that the present disclosure is not limited to a specific read selecting method.

Next, the seed generator 104 generates one or more seeds from the reads corrected by the corrector 102. Specifically, the seed generator 104 determines the lengths, the number, and the overlap lengths of the seeds to be generated from the respective reads in consideration of the lengths of the respective corrected reads, and generates the seeds from the reads according to the determined values. In an exemplary embodiment of the present disclosure, the respective reads output from the sequencer are subjected to a preprocess process at the corrector 102 to have different lengths, and thus the seed generator 104 determines the lengths, the number, and the overlap lengths of the seeds extracted from the respective reads in consideration of the lengths of the respective corrected reads.

The aligner 106 performs a global alignment operation of reads in a reference sequence using the seeds generated by the seed generator 104. Specifically, the aligner 106 determines candidate mapping positions of the reads by mapping the seeds to the reference sequence, and determines final mapping positions of the reads by performing the global alignment operation of the reads at the determined candidate positions in the reference sequence.

In an exemplary embodiment, the aligner 106 may be configured to perform a global alignment operation of reads whose partial sections have been removed by the corrector 102 as they are in a reference sequence. In this case, global alignment time of the aligner 106 may be reduced as much as the removed lengths of the reads subjected to global alignment.

For example, it is assumed that the total length of a read extracted from a sequencer is 100 bp, and a length of 30 by is removed from the total length of 100 bp. In this case, difference in alignment time between a case of performing a global alignment operation of the read of 100 bp as it is and a case of performing a global alignment operation of the corrected read of 70 bp is as follows (in expressions below, “0” denotes complexity of an algorithm).

Alignment time of 100 bp read: mapping time of seed+0(100−seed length)

Alignment time of 70 bp read: mapping time of seed+0(70−seed length)

Assuming that the seed length is 15 bp, the above example shows a global alignment time reducing effect of about 58%.

In another exemplary embodiment, the aligner 106 may perform a global alignment operation by replacing a section removed by the corrector 102 with one or more dummy bases. In exemplary embodiments of the present disclosure, a dummy base denotes a base that can be matched with any base in a reference sequence when it is matched with the reference sequence. For example, when a dummy base is indicated by a symbol “D,” a read “CDT” can be matched with all of CAT, CCT, CGT, and CTT in a reference sequence.

In the above-described exemplary embodiment, by adding as many dummy bases as 13 digits to the sample read from which the last 13 digits have been removed, the following is obtained.

Sample Read to which Dummy Bases are Added:

CTCAAGTAGCTGGCATTACAGGTGCTTGCCAAGACGCDDDDDDDDDDDDD

Even when dummy bases are added in this way, a portion to which the dummy bases have been added can be mapped with any bases, and thus it is possible to perform a global alignment operation of the dummy portion through only one time of scanning. Thus, even when the dummy bases are added, global alignment time is hardly affected. Alignment time of the read to which the dummy bases have been added may be calculated as follows.

Alignment Time of 70 pb Read to which Dummy Bases have been Added:

Mapping time of seed+(70−seed length)+0(1)

In the above expression, a portion presented as 0(1) is alignment time of dummy bases.

A detailed method of aligning a read in a reference sequence using a seed is well known in the art to which the present disclosure pertains, and detailed description thereof will be omitted herein.

A process of determining the lengths, number, and overlap lengths of seeds to be extracted from the length of a read at the seed generator 104 will be described in detail below. However, the following exemplary embodiments are merely examples, and the present disclosure is not limited to a specific method of determining the lengths, number, and overlap lengths of seeds.

First, a process of calculating the length of a seed will be described. In an exemplary embodiment of the present disclosure, the length of a seed calculated from a read is determined according to the length of the read. In other words, the greater the length of the read, the greater the length of the seed, that is, the length of the seed and the length of the read are in a proportional relationship. Specifically, the length of the seed may be determined according to Expression 1 below.

ceil[A×ln R_{length}+B−k₁]≦S_{length}≦ceil[A×ln R_{length}+B+k₂] [Expression 1]

Here, R_{length} is the length of a read, S_{length} is the length of a seed, and A, B, k₁, and k₂ are parameters for establishing a detailed proportional relationship between the seed and the read. The range of each parameter may vary according to the types, etc. of the read and a reference sequence, but in most DNA sequences, the parameters preferably have the following ranges.

A: a real number greater than or equal to 2.8 and less than or equal to 3.1

B: a real number greater than or equal to 2.6 and less than or equal to 3.0

k₁ and k₂: each a real number greater than or equal to 0 and less than or equal to 4

In the above expression, ceil(X) denotes the smallest integer among integers that are greater than or equal to X.

For example, assuming that A=2.966, B=2.804, and k₁=k₂=0, when the read length is 100, the seed length becomes ceil[2.966*ln(100)+2.804]=ceil(16.4629)=17. Also, when the read length is 500, the seed length becomes ceil[2.966*ln(500)+2.804]=ceil(21.2365)=22.

Assuming that A=2.966, B=2.804, and k₁=k₂=1, the seed length calculated according to Expression 1 and the read length has the following range.

i) when the read length is 75 bp, 15 bp≦seed length≦17 bp

ii) when the read length is 100 bp, 16 bp≦seed length≦18 bp

iii) when the read length is 150 bp, 17 bp≦seed length≦19 bp

iv) when the read length is 500 bp, 21 bp≦seed length≦23 bp

In general, the smaller the length of a seed, the more number of times the seed is mapped to a reference sequence, and the greater the length of a seed, the smaller number of times the seed is mapped to a reference sequence. In other words, when the length of a seed generated from a read is smaller than the ranges of Expression 1 mentioned above, the number of times that the seed is mapped to a reference sequence excessively increases, and thus the number of times of the global alignment operation in the subsequent global alignment process increases unnecessarily. On the other hand, when the length of the seed is greater than the ranges of Expression 1, the number of times that the seed is mapped to a reference sequence excessively decreases, and thus mapping accuracy deteriorates. Therefore, in the present disclosure, the length of the seed is set according to Expression 1 in consideration of the length of a read, and thereby it is possible to minimize complexity that may result from mapping while ensuring the quality of mapping.

When the reference sequence is a human genome sequence, the seed may be set in a range from 15 bp to 30 bp. As described above, in general, the smaller the length of a seed, the number of times that the seed is mapped to a reference sequence increases, and the greater the length of a seed, the number of times that the seed is mapped to a reference sequence decreases. Particularly in case of a human genome sequence, when the length of a seed is 14 or less, the number of mapping positions in the reference sequence drastically increases. Table 1 below shows the average number of times that a seed appears in the human genome according to a seed length.

TABLE 1

| Length of | Average number of |
|---|---|
| seed | times of appearance |
| 10 | 2,726.1919 |
| 11 | 681.9731 |
| 12 | 170.9185 |
| 13 | 42.7099 |
| 14 | 10.6470 |
| 15 | 2.6617 |
| 16 | 0.6654 |
| 17 | 0.1664 |

As can be seen from the above table, when the length of a seed is 14 or less, the seed-specific average numbers of times of appearance in the reference sequence are 10 or more, but when the length of a seed is 15, the average number of times of appearance in the reference sequence is reduced to less than 3. In other words, when the length of a seed is configured with 15 or more, an overlap of the seed can be remarkably reduced compared to a case in which the length of a seed is configured with 14 or less. Also, when the length of a seed is 30 or more, the number of times that the seed is mapped to the reference sequence excessively decreases, and thus mapping accuracy deteriorates. Therefore, when a reference sequence is the human genome sequence in the present disclosure, the length of the seed is configured with 15 to 30, and thereby it is possible to minimize complexity that may result from mapping while ensuring the quality of mapping.

When the length of a seed is determined using the method as described above, the number of seeds to be extracted from the read is calculated next using the length of the read and the length of the seed.

In an exemplary embodiment of the present disclosure, the number of seeds calculated from a read is determined according to the length of the read and the length of the seeds to be extracted from the read. Specifically, the greater the length of the read, the greater the number of the seeds, that is, the number of the seeds and the length of the read are in a proportional relationship, and the greater the length of the seeds, the smaller the number of the seeds, that is, the number of the seeds and the length of the seeds are in an inverse proportional relationship. Specifically, the number of the seeds may be determined according to Expression 2 below.

ceil[R_{length}/S_{length}−k₃]≦Sₙᵤₘ≦ceil[R_{length}/S_{length}+k₄] [Expression 2]

Here, R_{length} is the length of a read, S_{length} is the length of a seed, Sₙᵤₘ is the number of seeds, and k₃ and k₄ are parameters for determining the range of the number of seeds, each of which may be determined to be a real number greater than or equal to 0 and less than or equal to 4. Also, ceil(X) denotes the smallest integer among integers that are greater than or equal to X.

For example, assuming that k₃=k₄=1, the number of seeds according to the length of a read and the length of seeds are determined as follows.

1) When the read length is 100, and the seed length is 16,

ceil(100/16−1)=ceil(5.25)=6

ceil(100/16+1)=ceil(7.25)=8

Consequently, 6≦number of seeds≦8

2) When the read length is 75, and the seed length is 16,

ceil(75/16−1)=ceil(3.6875)=4

ceil(75/16+1)=ceil(5.6875)=6

Consequently, 4≦number of seeds≦6

3) When the read length is 150, and the seed length is 17,

ceil(150/17−1)=ceil(7.823)=8

ceil(150/17+1)=ceil(9.823)=10

Consequently, 8≦number of seeds≦10

When the length and number of seeds are determined using the method as described above, the overlap length of the seeds to be extracted from the read is calculated next.

FIG. 2 is a diagram illustrating an overlap between seeds in the present disclosure. As shown in the drawing, an overlap between seeds denotes a region in which seeds overlap each other, that is, a region that two seeds have in common. For example, as shown in the drawing, seed 1 and seed 2 have a portion filled with grey shade in common, and the portion becomes an overlap region between the two seeds. Also, in this case, an overlap length denotes the length of the region in which the two seeds overlap each other (overlap region). For example, when seed 1 has 5^{th} to 19^{th} bases of a read and seed 2 has 16^{th} to 30^{th} bases in the schematic exemplary embodiment, the overlap region between seeds 1 and 2 becomes 16^{th} to 19^{th} bases, and the overlap length becomes four bases. Meanwhile, there is no overlap region between seed 2 and seed 3, and the overlap length between the two seeds becomes 0.

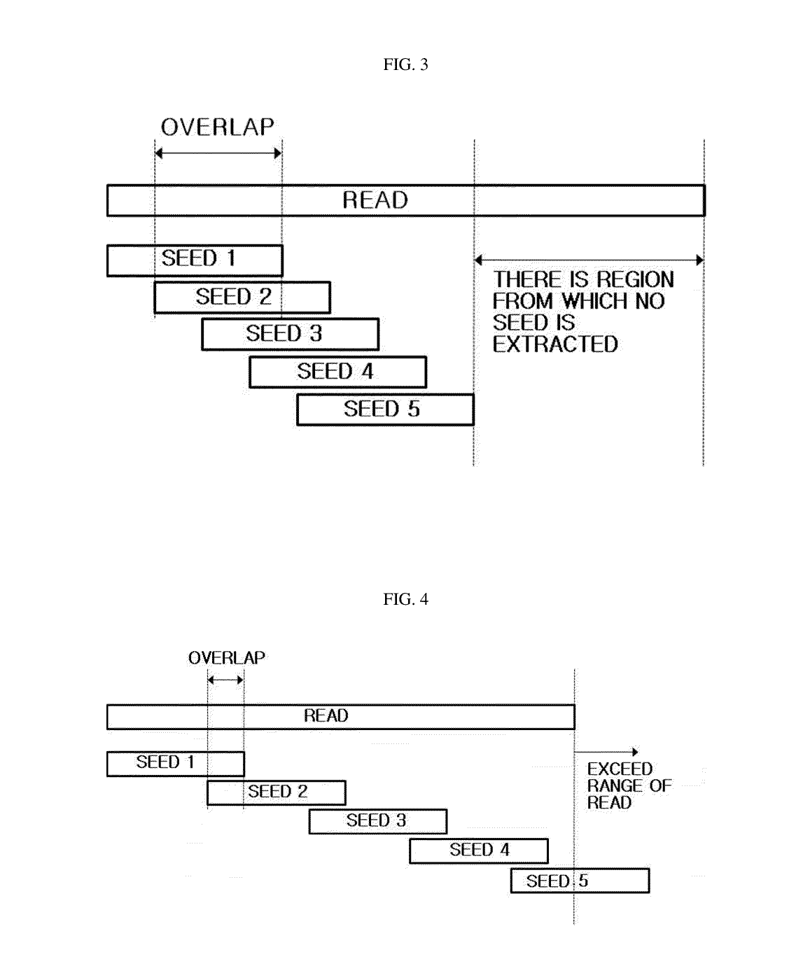

FIG. 3 and FIG. 4 are diagrams comparatively illustrating effects according to an overlap length between seeds in an exemplary embodiment of the present disclosure. For example, when an overlap length between seeds is set to be excessively large as shown in FIG. 3, seeds are extracted from only a part of a read, and there is a region that is not extracted as a seed in the read. On the other hand, when an overlap length between seeds is set to be excessively small as shown in FIG. 4, a part of a seed deviates from the range of a read, and it is impossible to extract the seed from the read. Considering these, in an exemplary embodiment of the present disclosure, an overlap length may be determined to maximize the region of a read from which seeds are extracted and not to exceed the range of the read.

In an exemplary embodiment of the present disclosure, an overlap length between seeds is determined according to the length of an input read, and the length and number of seeds. Specifically, the overlap length may be determined according to Expression 3 below.

$$ceil [ max ( \frac{{S}_{length} \times {S}_{num} - {R}_{length}}{{S}_{num} - 1} , 0 ) ] - {k}_{5} \leq overlap \leq ceil [ max ( \frac{{S}_{length} \times {S}_{num} - {R}_{length}}{{S}_{num} - 1} , 0 ) ] + {k}_{6} \qquad [ Expression 3 ]$$

Here, overlap is an overlap length, R_{length} is the length of a read, S_{length} is the length of a seed, Sₙᵤₘ is the number of seeds, and k₅ and k₆ are parameters for determining the range of the overlap length, each of which may be determined to be an integer greater than or equal to 0 and less than or equal to 4. Also, ceil(X) denotes the smallest integer among integers that are greater than or equal to X.

Meanwhile, the overlap length cannot be a negative number semantically, and thus k5 and k6 should satisfy the following range.

$$ceil [ max ( \frac{{S}_{length} \times {S}_{num} - {R}_{length}}{{S}_{num} - 1} , 0 ) ] \geq {k}_{5} , {k}_{6} \qquad [ Expression 4 ]$$

For example, assuming that k₅=k₆=0, when the read length is 75, the seed length is 16, and the number of seeds is 5, the overlap length is determined according to Expression 3 as follows.

Overlap length=ceil(max(16*5−75/4.0))=ceil(1.25)=2

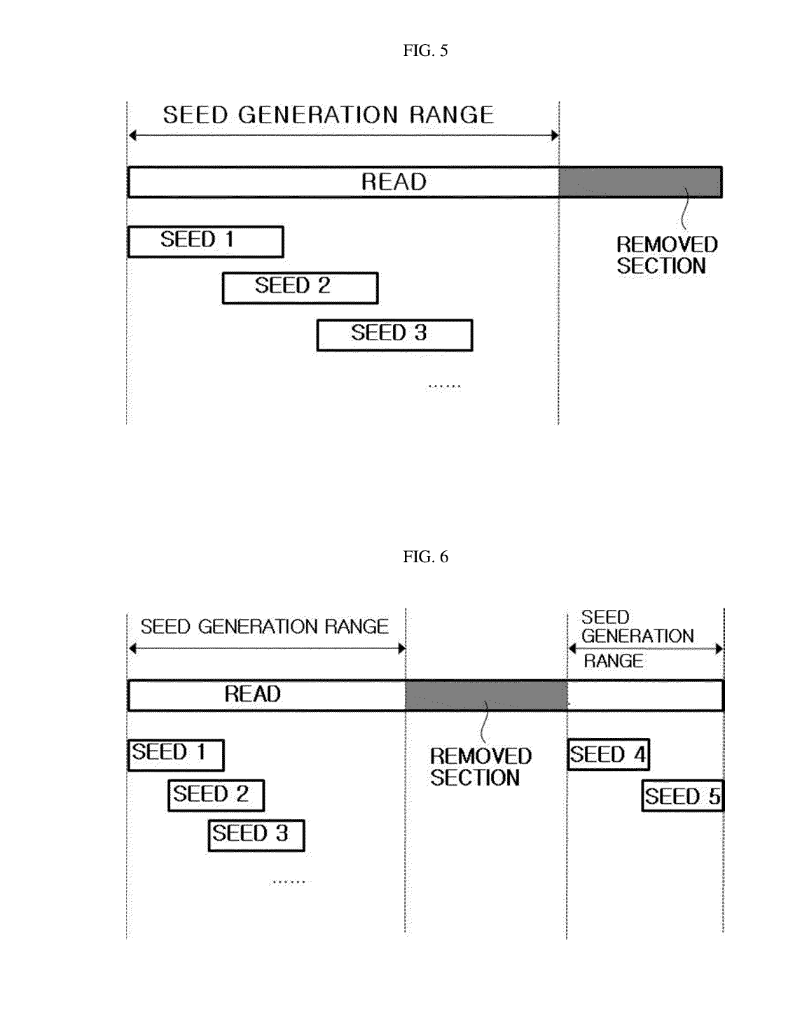

Meanwhile, in an exemplary embodiment of the present disclosure, the seed generator 104 may set the length, number, or overlap length of seeds differently according to the position of a section removed from a read. For example, when a rear end portion of a read is removed as shown in FIG. 5, the seed generator 104 determines the length, number, or overlap length of seeds on the basis of the length of the read excluding the removed section. In other words, in this case, the length, number, or overlap length of generated seeds varies according to the original length of the read and the length of the removed section.

Meanwhile, when a middle portion of a read is removed, and the read is split into two or more segments as shown in FIG. 6, the seed generator 104 may separately determine the length, number, or overlap length of seeds for each of the split segments. In other words, in the drawing, the length, number, or overlap length of seeds extracted from the left section of the removed section is determined according to the length of the left section of the removed section, and this is the same for seeds extracted from the right section of the removed section. Accordingly, in the drawing, seed 1 to seed 3 may have a different length, number, or overlap length than those of seed 4 and seed 5.

In the present disclosure, a detailed method of generating seeds from a read is not limited in particular. In other words, in consideration of a part or the whole of a corrected read, the seed generator 104 generates a plurality of seeds having the length, number, and overlap length calculated according to the above-described method. For example, seeds may be generated by splitting the whole or a specific section of a read into a plurality of segments, or combining split segments. In this case, the generated seeds may be consecutively connected with each other. However, the generated seeds are not necessarily connected in succession, and it is also possible to configure seeds with a combination of segments that are apart from each other in the read. In brief, in the present disclosure, a method of generating seeds from a read is not particularly limited, and various algorithms for extracting seeds from a part or the whole of a read can be used without limitation.

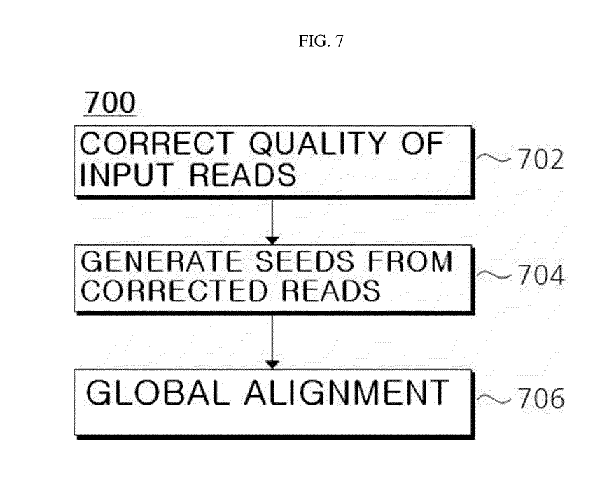

FIG. 7 is a flowchart illustrating a method of aligning a genome sequence according to an exemplary embodiment of the present disclosure.

First, the corrector 102 corrects the quality of reads input from a sequencer (702). As described above, by removing partial sections of the input reads in consideration of quality scores of the reads, etc., the corrector 102 may correct the quality of the reads. A detailed quality correcting method of the corrector 102 has been described above.

Next, the seed generator 104 generates one or more seeds from the corrected reads (704), and the aligner 106 performs a global alignment operation of the reads in a reference sequence using the seeds generated in step 704 (706).

In exemplary embodiments of the present disclosure, it is possible to increase a mapping rate and speed that are evaluation indicators for general genome sequence alignment algorithms, and also improve accuracy in detecting variation related to a disease (single-nucleotide polymorphism insertion and deletion (SNP/INDEL)).

To accurately detect a variation from a genome sequence, it is very important to accurately map a read to a reference sequence. In particular, when a read is mapped using a seed extracted from a section of low quality in the read, mapping accuracy deteriorates. To solve this problem, exemplary embodiments of the present disclosure are configured to prevent a seed from being extracted from a section of low quality in a read by removing the section from the read in advance. Thus, in exemplary embodiments of the present disclosure, it is possible to prevent a seed extracted from a section of low quality from affecting detection of variation related to a disease after mapping of a read.

Table 2 below comparatively shows the variation detection performance of a genome sequence reassembly system and/or apparatus according to an exemplary embodiment of the present disclosure. To verify an effect of the present disclosure, the number of detected variations obtained before the present disclosure is applied and that obtained after the present disclosure is applied are compared using breast cancer 1 (BRCA1) gene data including 330 known variations (200 SNP and 130 INDEL).

TABLE 2

| | Number of |
|---|---|
| | variations |
| Before application of present disclosure | 290 (88%) |
| After application of present disclosure | 316 (96%) |

As can be seen from the above table, while the number of variations detected before the quality of reads was corrected according to the present disclosure was 290, the number of variations detected after application of the present disclosure was 316, which shows performance improvement of about 8%.

Meanwhile, exemplary embodiments of the present disclosure may include a computer-readable recording medium including a program for performing the methods, described herein, using a general purpose or specialized computer. The computer-readable recording medium may separately include program commands, local data files, local data structures, etc. or include a combination of them. The medium may be specially designed and configured for the present disclosure, or known and available to those of ordinary skill in the field of computer software. Examples of the computer-readable recording medium, in a non-transitory aspect, include magnetic media, such as a hard disk, a floppy disk, and a magnetic tape, optical recording media, such as a CD-ROM and a DVD, magneto-optical media, such as a floptical disk, and hardware devices, such as a ROM, a RAM, and a flash memory, specially configured to store and perform program commands. Examples of the program commands may include high-level language codes executable by a computer using an interpreter, etc. as well as machine language codes made by compilers. Inasmuch as a computer is a device that is well known to those familiar with this field, a detailed description, of the hardware processor of such a computer, or of the manner in which the computer-readable recording medium may be employed to implement the various devices or units, and to control the variously described operations using the processor, is not provided. Likewise, a description of well known output devices such as displays, printers, data files on magnetic or optical media, and the like, for outputting results, is also not provided.

In exemplary embodiments of the present disclosure, the quality of reads generated from a sequencer is corrected, and thus it is possible to maintain the quality of reads at a certain level or higher regardless of the lengths of the reads. In other words, by performing genome sequence analysis with only reads whose quality is ensured, accuracy in the genome sequence analysis can be improved. In addition, in exemplary embodiments of the present disclosure, a probability that a read will be wrongly mapped to a reference sequence is reduced, and thus it is possible to increase the speed of genome sequence analysis by reducing the total number of times of global alignment.

In particular, when reads generated from a sequencer are paired-end reads, the lengths of the respective sequences of the paired-end reads are changed through quality correction. In this case, a candidate group of reads to be used in mapping can be reduced compared to a case of using paired-end reads having only sequences of the same length, and thus it is possible to improve mapping accuracy and speed. With such improvements in mapping accuracy and speed, accuracy in SNP detection also can be improved.

It will be apparent to those skilled in the art that various modifications can be made to the above-described exemplary embodiments of the present disclosure without departing from the spirit or scope of the present disclosure. Thus, it is intended that the present disclosure covers all such modifications provided they come within the scope of the appended claims and their equivalents.

What is claimed is:

1. An apparatus, intended for use in aligning a genome sequence, comprising:
a corrector configured to correct a respective quality of each of a plurality of input reads so as to provide corrected reads;
a seed generator configured to generate one or more seeds from the corrected reads so as to provide one or more generated seeds;
an aligner configured to use the one or more generated seeds to perform a global alignment operation, of the corrected reads, in a reference sequence; and
a hardware processor configured to implement at least one of the corrector, the seed generator, and the aligner.

2. The apparatus of claim 1, wherein the corrector is further configured to provide the corrected reads by removing one or more partial sections of at least one of the plurality of input reads.

3. The apparatus of claim 2, wherein the corrector is further configured to remove the one or more partial sections of the at least one of the plurality of input reads in response to corresponding quality scores of the plurality of input reads.

4. The apparatus of claim 3, wherein the corrector is further configured to remove the one or more partial sections from the input reads including bases having quality scores less than a predetermined value.

5. The apparatus of claim 4, wherein the corrector is further configured to remove ones of the one or more partial sections, from the input reads, when the ones of the one or more partial sections also respectively exceed a predetermined length.

6. The apparatus of claim 2, wherein the corrector is further configured to remove ones of the one or more partial sections having bases indicated as being unclear.

7. The apparatus of claim 2, wherein the corrector is further configured to remove a given partial section, of the one or more partial sections, in response to a determination that a mathematical operation, performed with respect to one or more quality scores of the given partial section, provides a result that is less than a predetermined value.

8. The apparatus of claim 2, wherein the corrector is further configured to remove ones of the one or more partial sections from bases in response to detecting mismatches during exact matching, between the plurality of input reads and the reference sequence, to final bases of the plurality of input reads.

9. The apparatus of claim 2, wherein the corrector is further configured to discard ones of the corrected reads having respective lengths less than a predetermined value.

10. The apparatus of claim 2, wherein the corrector is further configured to discard a given corrected read, of the corrected reads, in response to a determination that a mathematical operation, performed with respect to one or more quality scores of the given corrected read, provides a result that is less than a predetermined value.

11. The apparatus of claim 1, wherein the seed generator is further configured to generate the one or more seeds with respective attributes set based on respective lengths of the corrected reads, the attributes including one or more of seed generation length, seed generation number, and seed generation overlap length.

12. The apparatus of claim 11, wherein the corrector is further configured to split the corrected reads into two or more segments, and the seed generator is further configured to set the respective attributes with respect to the respective split segments.

13. The apparatus of claim 2, wherein the aligner is further configured to replace the removed one or more partial sections with one or more dummy bases before performing the global alignment operation.

14. A method of aligning a genome sequence, comprising:
correcting, at a corrector, a respective quality of each of a plurality of input reads so as to provide corrected reads;
generating, at a seed generator, one or more seeds from the corrected reads so as to provide one or more generated seeds; and
using the one or more generated seeds, at an aligner, to perform a global alignment operation, of the corrected reads, in a reference sequence;
wherein one or more of the corrector, the seed generator, and the aligner are implemented by a hardware processor.

15. The method of claim 14, wherein the corrected reads are provided by removing one or more partial sections of at least one of the plurality of input reads.

16. The method of claim 15, wherein the correcting of the quality of the input reads includes removing the one or more partial sections of the at least one of the plurality of input reads in response to corresponding quality scores of the plurality of input reads.

17. The method of claim 16, wherein the corrected reads are provided by removing sections from the input reads including bases having quality scores less than a predetermined value.

18. The method of claim 17, wherein the correcting of the quality of the input reads includes removing ones of the one or more partial sections, from the input reads, when the one or more partial sections also respectively exceed a predetermined length.

19. The method of claim 15, wherein the corrected reads are provided by removing sections having bases indicated as being unclear.

20. The method of claim 15, wherein the corrected reads are provided by removing a given partial section, of the one or more partial sections, in response to a determination that a mathematical operation, performed with respect to one or more quality scores of the given partial section, provides a result that is less than a predetermined value.

21. The method of claim 15, wherein the corrected reads are provided by removing ones of the one or more partial sections from bases in response to detecting mismatches during exact matching, between the plurality of input reads and the reference sequence, to final bases of the plurality of input reads.

22. The method of claim 15, wherein the correcting of the quality of the input reads further includes discarding ones of the corrected reads having respective lengths less than a predetermined value.

23. The method of claim 15, wherein the correcting of the quality of the input reads further includes discarding a given corrected read, of the corrected reads, in response to a determination that a mathematical operation, performed with respect to one or more quality scores of the given corrected read, provides a result that is less than a predetermined value.

24. The method of claim 14, wherein the generating of the one or more seeds is performed according to respective attributes set based on respective lengths of the corrected reads, the attributes including one or more of seed generation length, seed generation number, and seed generation overlap length.

25. The method of claim 24, wherein the providing of the corrected reads includes splitting the corrected reads into two or more segments, and the generating of the one or more seeds includes setting the respective attributes with respect to the respective split segments.

26. The method of claim 15, wherein the performing of the global alignment operation is preceded by replacing the removed one or more partial sections with one or more dummy bases.
